(19) United States
(12) Patent Application Publication
(10) Pub. No.: US 2025/0272955 A1
(43) Pub. Date: Aug. 28, 2025

(54) SYSTEM AND METHOD FOR DETERMINING A COMPREHENSIVE CARBON FOOTPRINT

(71) Applicants: Varun Garg, Houston, TX (US); Hitesh Singh, Gautam Buddha Nagar (IN); Vivek Kumar, Haryana (IN)

(72) Inventors: Varun Garg, Houston, TX (US); Hitesh Singh, Gautam Buddha Nagar (IN); Vivek Kumar, Haryana (IN)

(73) Assignee: Digital Glyde Inc., Houston, TX (US)

(21) Appl. No.: 18/589,555

(22) Filed: Feb. 28, 2024

(51) Int. Cl. G06V 10/764; G06V 20/13

(52) U.S. Cl. CPC G06V 10/764; G06V 20/13

(57) ABSTRACT

A system and method for determining the carbon footprint of a land area based upon emissions of GHGs and carbon sequestration of ABGs. The system makes use of satellite images, public-source emissions data and AGB data to produce a comprehensive carbon footprint metric for a designated land area.

### TECHNICAL FIELD

The invention is a system and method for determining a carbon footprint for a specific land area.

### BACKGROUND OF INVENTION

There is nearly absolute consensus that human activity has contributed enough green-house gases (GHGs) to be causing an increase in average global temperature that, in turn, is causing outsized climatic changes.

Globally, different land areas contribute different amounts of GHGs depending upon population, types of power generation plants, population density, and the like. Thus, no two land areas of approximately the same size are likely to have identical carbon footprints, particularly if one is rural and has significant green-plant coverage whereas the other is urban, with crowded buildings, lots of automobiles, and scant vegetation.

Attempting to slow down or stop global climate change, by reducing GHGs, is a global problem that requires local solutions. That, in turn, requires that the carbon footprint—the contribution to GHGs—from any land area be as precisely calculated, as possible, in order to determine how best to lower its carbon footprint.

One way to lower carbon footprint is to reduce emissions from coal-burning power plants, or replace many gasoline-powered vehicles with electric-powered vehicles, and so on. But, to determine the best approach means having an accurate assessment of carbon footprint based not only on GHG emissions but also on carbon sequestration. Where carbon footprint is measured solely in terms of GHG emissions, one may obtain a value that is too high because sequestration has actually reduced net emissions. As a result, actions taken to reduce emissions may be over-engineered, costing more than necessary to obtain a desired carbon footprint metric.

However, most systems and method for determining carbon footprint rely on gauging GHG emissions without taking carbon sequestration into consideration.

### BRIEF DESCRIPTION OF INVENTION

The invention is a system and method for gauging GHG emission based on object-based identification and categorical emission metrics then integrating carbon sequestration metrics for the same land area and finding a comprehensive, accurate carbon footprint.

The invention makes use of real-time data and historical data, plus machine-learning models, to continuously refine and improve the accuracy of its findings. Carbon emissions metrics are based on satellite imagery for the land area that has been processed to provide accurate object identification and then correlate it with public-source data showing carbon emissions for the different categories of objects detected. In addition, carbon sequestration is determined by satellite images, filtered for specific spectral bands, that can be used to calculate Normalized Difference Vegetation Index (NDVI), plus on-ground observations as well as historical data for Above-Ground Biomass (AGB).

By using the same units of measure for carbon data related to emissions and sequestration, one may find a final carbon footprint value that covers the net effect of emissions and sequestration, and is therefore comprehensive.

The invention combines methods and systems that enable capturing real-time emission and AGB data, coupled with public-source historical data, then integrated the data so as to arrive at a final carbon footprint value for any specific land area.

The supporting system makes use of satellite images and historical data obtained via the Internet, then uses a machine-learning model to support object identification, and is operative to produce a final carbon footprint for a designated land area that is based on blending GHG emissions data with NDVI/AGB sequestration data. The final result may be far more accurate than one based solely upon historical, or even real-time, emissions data.

### BRIEF DESCRIPTION OF DRAWINGS

FIG. 1 depicts an embodiment of the system.

FIG. 2 illustrates a method embodiment for obtaining sequestration metrics.

FIG. 3 illustrates a method embodiment for obtain object-based emissions data.

FIG. 4 illustrates an embodiment for combining the data from methods shown on FIGS. 1 and 2 to obtain an aggregate carbon-footprint value.

FIG. 5 illustrates a method for using satellite images to find NDVI values.

FIG. 6 illustrates a method for using satellite images and machine-learning models to determine emissions values and combine with AGB findings

FIG. 7 illustrates a method for determining a final carbon-footprint value.

FIG. 8 depicts a system embodiment that supports the methods for finding carbon emissions, carbon sequestration, and combining them to obtain a comprehensive final value.

### DETAILED DESCRIPTION OF INVENTION

Nearly all scientists believe that human activity is responsible for the huge increase in GHGs and the change in climatic conditions as a result of increased global temperatures.

Although the problem is global, the solution depends upon local actions. Cutting back on GHGs may mean converting coal-fired power plants to other types of fuels, reducing the number of gasoline-powered vehicles in favor of electric-powered vehicles, and so on.

The term “carbon foot print” was coined to describe the emissions of GHGs from particular land areas. An individual's house, for example, has a carbon footprint resulting from how it is heated and cooled. A neighborhood has a carbon footprint resulting from the carbon footprints of the homes within that neighborhood. A city has a carbon footprint resulting from the contribution of all its neighborhoods. And, so on.

Reducing GHGs has become a global effort, and the efficacy of various solutions depends upon determining accurate initial conditions. What is the carbon footprint of a land area, now, and how has it changed after reduction solutions were put in place? If a carbon footprint value is inaccurately higher than actual, it may cause excessive cost and engineering for solutions. Therefore, it is important that the carbon footprint be as accurately determined, as possible, both before and after a solution has been adopted. Only that accuracy will help find the best solution and keep track of its success.

There are satellites in place that can be guided to photograph specific land areas. These photographs can play a key part in accurately determining that land area's carbon footprint. Its emissions can be determined by taking stock of the various objects contained within the land area, and each object's categorical carbon emission. That can provide an accurate measure of GHG emission for the land area.

But, all objects do not just emit GHGs. Green plant biomass will sequester GHGs during daylight hours. Thus, it is possible that in a land area having no people and vast vegetation, the carbon footprint will be relatively high whereas in a close-by land area having scant vegetation along with high population density, housing and transportation, the carbon footprint will be relatively high. For land areas that have both civilization and vegetation, the carbon footprint will be higher than the area with no people and vast vegetation, but lower than the area with high population density, housing and transportation. Currently, though, systems and methods for determining carbon footprint values are not set up for combining emission and sequestration metrics to arrive at a comprehensive, combined value.

The invention herein disclosed and claimed is a system and method for determining the emission carbon footprint metrics and the vegetation sequestration footprint metrics. By combining the two metrics, one is able to find a comprehensive metric that more accurately describes a particular land area.

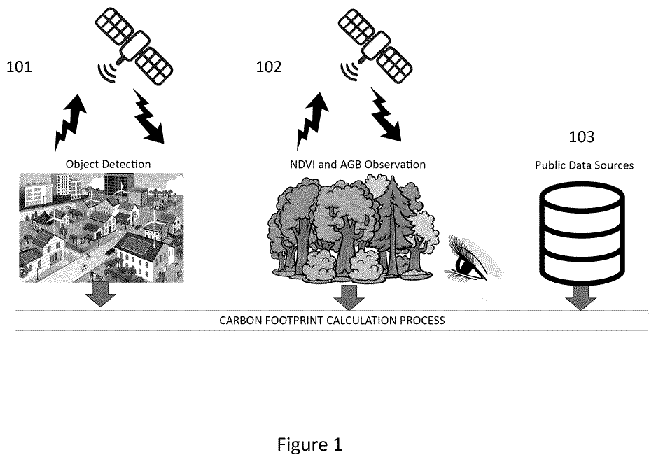

In FIG. 1, satellites are used for both emission and sequestration measures. In 101, the satellite is used to capture objects within the land area, such as roads, cars, buildings and the like. A model can be fashioned that takes into consideration the total number of objects, and their breakdown into categorical numbers, then calculating an emission carbon footprint based on processing that data. In 102, a satellite captures a land area, and its vegetation can be highlighted by selecting near-infra-red and red spectral bands, thereby effectively filtering out emission objects. Using that filtered image, and NDVI calculations, one can obtain a measure for sequestration. Modifying the NDVI numbers with numbers based on observations of AGB will provide a more accurate sequestration value. And, in 103, public-source data on both emissions and sequestration can be gathered and used to validate or modify the NDVI and AGB findings.

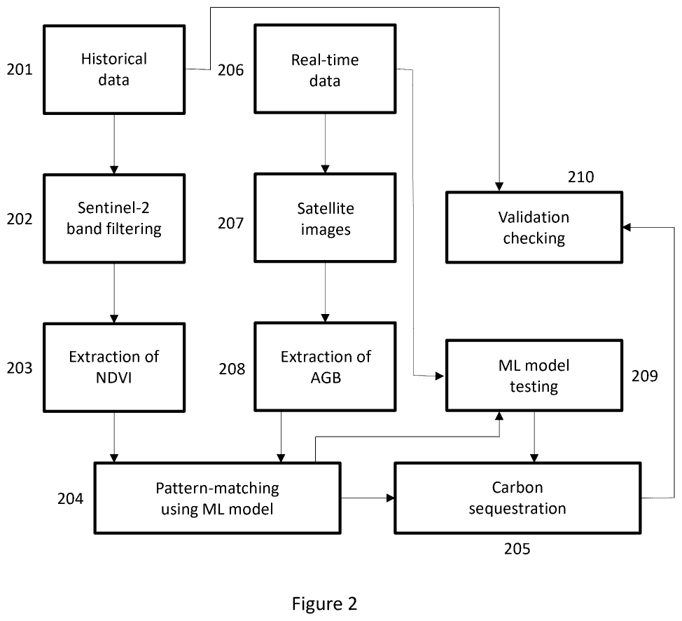

FIG. 2 is a method flow for finding the sequestration carbon data. Historical satellite data (201), filtered for specific spectral bands (202), is used to extract NDVI data (203). Real-time data (206) and real-time satellite images (207) support an extraction of AGB data. The NDVI and AGB data is fed into a machine-learning model (204) for pattern matching. Based on the pattern-matching, carbon sequestration can be determined (205). The historical data and sequestration data is used for validation checking (210) and real-time data plus ML pattern-matching is used to support model testing.

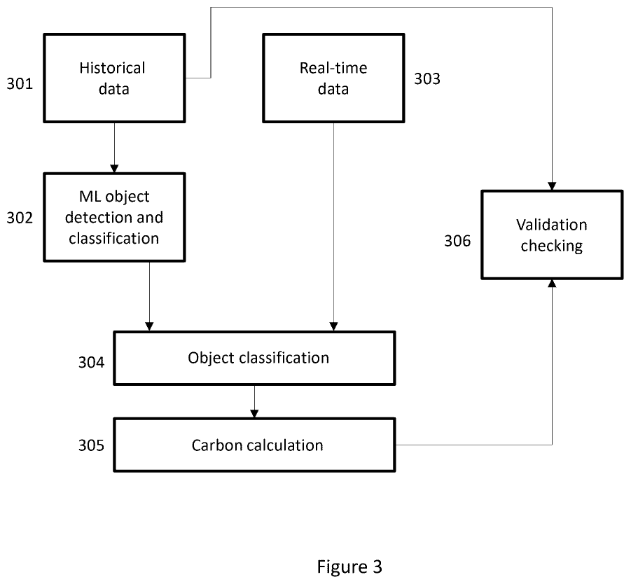

FIG. 3 is a method flow for finding emission data. Historical data (satellite images) 301 is passed through an ML model for object identification and classification (302 and 304). The results are modified by real-time data (303). And, carbon calculation is then completed (305). Validation checking (306) makes use of historical data and real-time carbon calculation data.

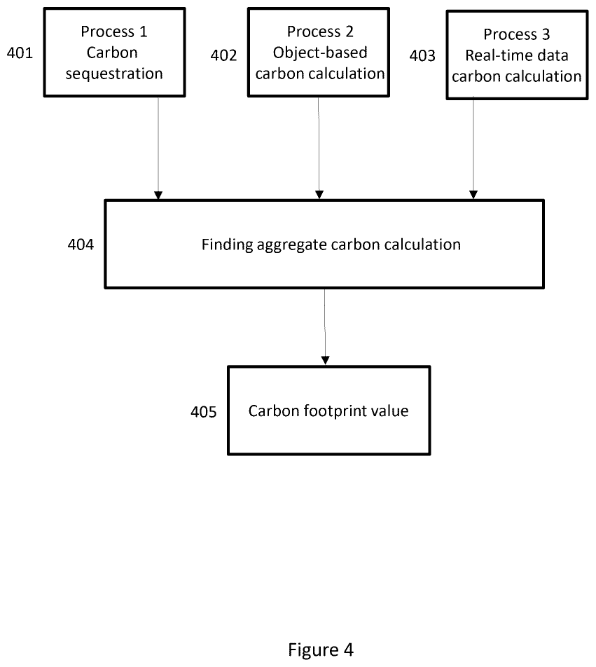

FIG. 4 shows how three processes and their results are combined to provide a carbon footprint value. The data from process 1 (sequestration) 401, the data from process 2 (object-based carbon calculation) 402, and the data from process 3 (real-time data carbon calculation) 403 is each input to a process for finding an aggregate value, 404. That aggregate value becomes the final carbon footprint metric (405).

The following figures provide more detail about the method steps for sequestration, emission and aggregation.

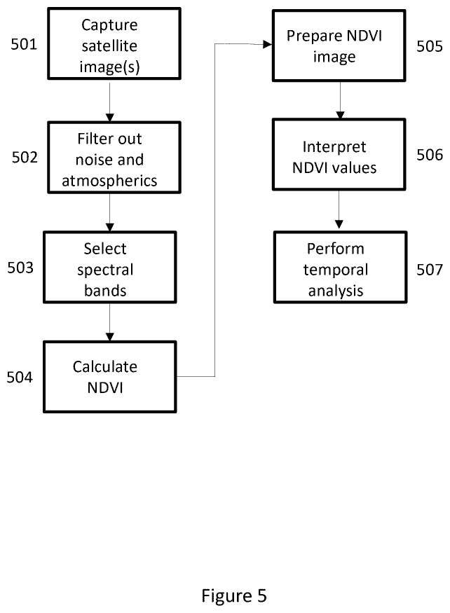

In FIG. 5, satellite images are captured (501), then filtered for noise and atmospherics (502), near-infra red and red spectral bands are selected (503) and an NDVI value is calculated (504). And NDVI image is created (505) allowing interpretation of NDVI values (506). Optionally, by repeating these steps over time, a temporal analysis can be made (507).

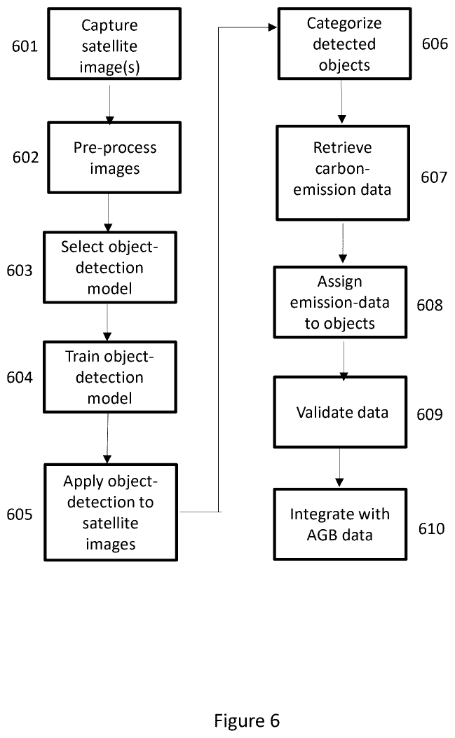

FIG. 6 shows the method for determining emission values. Satellite images are captured (601). These are then pre-processed to highlight the various objects (602). An object-selection ML model is selected (603) and trained using appropriate labeled data (604). The model is then applied to the pre-processed satellite images (605). The objects are categorized (606). Categorical emission data is retrieved (607), and assigned to the objects detected (608). The data is validated (609) and integrated with the AGB data (610).

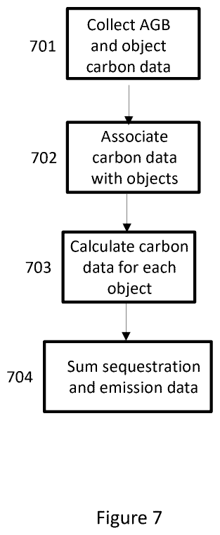

The last method figure, FIG. 7, shows the final steps. The object-based and AGB data is collected (701), carbon data is associated with detected objects (702), carbon data is calculated for the objects (703) and sequestration and emission data is summed (704).

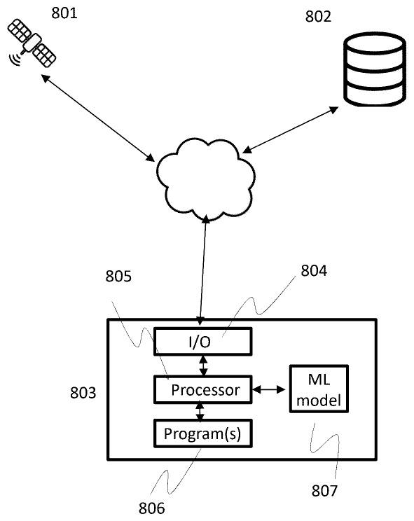

The hardware system that supports the aforementioned methods is shown in an embodiment in FIG. 8. Satellites (801) provide images based on land-area coordinates. Public data sources (802) provide emission and sequestration data used for modifying models and for validity checking. A processing system (803) comprising input-output subsystem (804), processing subsystem (805) at least one program (806) and an ML model (807) support the methods used for determining sequestration and emission based on satellite images (real time), satellite images (historic) and public-source emission and sequestration data for the designated land area.

The drawings and method flows are exemplary and should not be read as limiting the invention scope.

What is claimed is:

1. A method comprising:
determining a carbon calculation for a land area based on carbon emissions;
determining a carbon calculation for carbon sequestration of the land area based on a correlation of NDVI and AGB;
determining a carbon calculation for the land area based on public-data sources;
processing the aggregation of carbon calculations from carbon emissions, carbon sequestration and public data sources; and
determining a single carbon footprint calculation for the land area based on the processed aggregation of carbon calculations from carbon emissions, carbon sequestration and public data sources.

2. A method as in claim 1 wherein:
determining the carbon calculation for the land area based on carbon emissions uses object-detection data based on historical and real-time satellite images of the land area.

3. A method as in claim 1 wherein:
determining the carbon calculation for the land area based on carbon sequestration uses NDVI and AGB data based on historical and real-time satellite images of the land area.

4. A method as in claim 1 wherein:
determining the carbon calculation for the land area based on carbon emissions uses machine-learning modeling for breadth of object recognition and increasing accuracy of object recognition.

5. A method as in claim 1 wherein:
determining the carbon calculation for the land area based on carbon sequestration uses machine-learning modeling for breadth of pattern matching and increasing accuracy of pattern recognition.

6. A system supporting object-based emissions and AGB sequestration comprising:
at least one satellite operative to provide images of a land area based on the land area's coordinates;
a public source of emission and sequestration carbon footprint data;
a processing subsystem comprising:
an input-output subsystem;
a processor;
at least one program; and
a machine-learning model subsystem.
